(19) United States
(12) Patent Application Publication
(10) Pub. No.: US 2016/0305405 A1
(43) Pub. Date: Oct. 20, 2016

(54) WIND TURBINE COMPRISING A SEGMENTED TOWER AND FOUNDATION

(71) Applicant: WOBBEN PROPERTIES GMBH, Aurich (DE)

(72) Inventor: Martin KRAFT, Aurich (DE)

(21) Appl. No.: 15/100,592

(22) PCT Filed: Dec. 4, 2014
(86) PCT No.: PCT/EP2014/076601

§ 371 Date: May 31, 2016

(30) Foreign Application Priority Data
Dec. 6, 2013 (DE) 10 2013 225 128.9

(51) Int. Cl. F03D 13/20; E02D 27/42; E04H 12/12; E04H 12/34; E04H 12/16

(52) U.S. Cl. CPC F03D 13/22; E04H 12/342; E04H 12/16; E04H 12/12; E02D 27/425; F05B 2240/912

(57) ABSTRACT

A wind turbine with a foundation and a tower with multiple tower segments, placed on the foundation is provided. The foundation has a tower base which is at least partially cast in the foundation. The tower base has at least two segments and a lower tower segment of the tower is tensioned together with the segments of the tower base, in particular via tensioning rods.

### BACKGROUND

1. Technical Field

The present invention relates to a wind turbine and a wind turbine tower.

2 Description of the Related Art

The tower of a wind turbine is typically placed on a foundation.

In the priority-establishing German patent application, a search made by the German Patent and Trademark Office identified the following documents: EP 2 518 240 A1; DE 10 2008 010 660 B3; DE 102 26 996 A1; JP 2010-236224 A; DE 603 17 372 T2; DE 20 2011 001 695 U1; US 2010/0024311 A1; DE 10 2011 085 947 A1 and DE 102 30 273 B3.

### BRIEF SUMMARY

The present invention provides a wind turbine and a tower of a wind turbine which have an improved connection between the tower and the foundation.

A wind turbine with a foundation and a tower, with multiple tower segments, placed on the foundation is provided. The foundation has a tower base which is at least partially cast in the foundation. The tower base has at least two segments and a lower tower segment of the tower is tensioned together with the segments of the tower base via tensioning elements.

According to an aspect of the present invention, an upper segment of the tower base has a conical segment having multiple through bores, through holes or sheaths for receiving tensioning rods. The through bores, through holes or sheaths extend parallel to the longitudinal direction of the tower base.

According to a further aspect of the present invention, the external diameter of the lower tower segment is smaller than the external diameter of the lower end of the tower base.

According to an aspect of the present invention, the wind turbine has an anchor ring as part of the tower base, which is embedded in the concrete of the foundation as part of the tower base. First ends of the tensioning rods are tensioned on the anchor ring. Second ends of the tensioning rods are tensioned in a flange at the upper end of the tower base or on the lower end of the lower tower segment.

According to a further aspect of the present invention, a fireproof seal is provided in the region of the tower base or in one of the lower tower segments.

Other embodiments of the invention are the subject of the subclaims.

### BRIEF DESCRIPTION OF THE SEVERAL VIEWS OF THE DRAWINGS

Advantages and exemplary embodiments of the invention are explained in detail below with reference to the drawings, in which:

FIG. 1 shows a schematic view of a wind turbine according to the invention.

FIG. 2 shows a schematic view in section of a transition between a foundation and a tower of a wind turbine according to a first exemplary embodiment.

FIG. 3 shows a further view in section of a transition between a foundation and a tower of a wind turbine according to the first exemplary embodiment, and

FIG. 4 shows a further schematic view in section of a transition between a foundation and a tower of a wind turbine according to the first exemplary embodiment.

### DETAILED DESCRIPTION

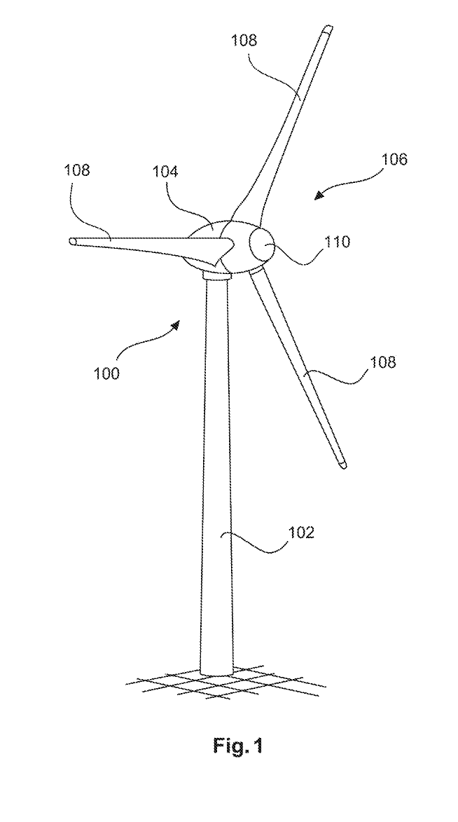

FIG. 1 shows a wind turbine 100 with a tower 102 and a nacelle 104. A rotor 106 with three rotor blades 108 and a spinner 110 is arranged on the nacelle 104. In operation, the rotor 106 is set in rotational motion by the wind and consequently drives a generator in the nacelle 104. The pitch angle of the rotor blades 108 can be changed by pitch motors on the rotor blade roots of the respective rotor blades 108. The tower 102 can consist of multiple superposed tower segments 102a, for example in the form of precast concrete parts, and be placed on a foundation 500. The segments are tensioned by means of tensioning means (for example, tensioning cables, tensioning strands).

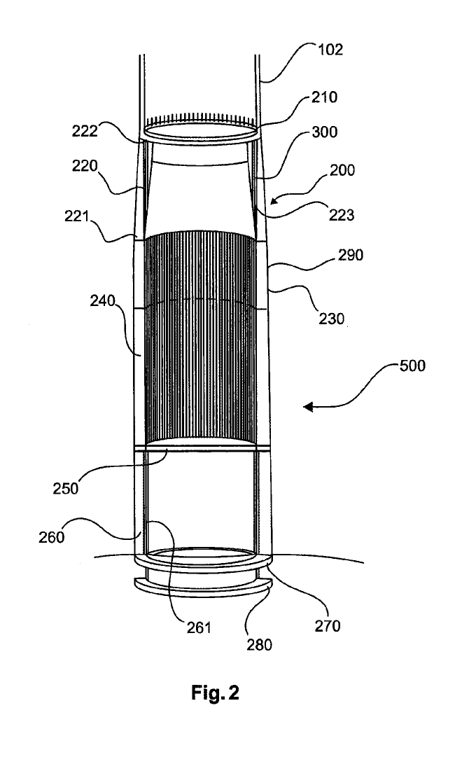

FIG. 2 shows a schematic view in section of a transition between a foundation and a tower of a wind turbine according to a first exemplary embodiment. A tower base 200 is provided in a foundation 500 of the wind turbine 100. The tower base 200 has an anchor ring 280, a first foundation segment 260 with a lower flange ring 270, a second foundation segment 240, a third foundation segment 230, and a fourth segment 220. The fourth segment 220 has a conical external diameter, i.e., the external diameter of a first end 221 of the segment 220 is greater than the external diameter of a second end 222. A flange ring 210 is provided at the second end 222 of the segment 220. A lower tower segment 102a can be placed on this flange ring 210.

The segments 220, 230, 240 and 260 can be produced as precast concrete segments. The segments can optionally have a multi-part design.

Multiple tensioning rods 300 can optionally be provided between the ring 280 and the flange 210 so that tensioning between the lower ring 280 and the flange 210 on the fourth segment 220 can be effected. In other words, the segments 260, 240, 230 and 220, and the lower tower segment 102a, are tensioned to one another via multiple tensioning rods 300. Tensioning strands or tensioning cables can also optionally be used.

A fireproof seal 250 can optionally be provided between the first and second segment 260, 240. The fireproof seal 250 can be produced from concrete and can optionally have a multi-part design. The seal 250 can be fastened to one of the tower segments or one of the segments of the tower base. This can be effected by means of a retaining ring which is fastened to one of the segments.

Alternatively or additionally, a projection can be provided on one of the segments of the tower of the tower base, which serves as a supporting or bearing surface for the seal 250. The projection can optionally extend around the entire circumference (or at least part of it) of the segment of the tower base or the tower segment.

The seal 250 has a fireproof design, i.e., it can withstand temperatures of, for example, up to 800° C. (or up to 1000° C.) for longer than 10 minutes.

A transformer or a power cabinet can be provided in the region which is closed or covered by the seal 250. The power cabinet can hereby have multiple switch elements, for example for an inverter or for a converter.

The seal 250 can optionally be fastened to one of the segments of the tower base or to one of the tower segments.

The tensioning rods 300 can optionally be provided in the region of the second and third segment 240, 230 inside the segments, i.e., inside the foundation segments.

The first segment 260 can optionally have multiple through bores or sheaths 261 in which the tensioning rods 300 extend.

The fourth segment 220 also has multiple sheaths or through holes 223. These sheaths or through holes 223 optionally extend parallel to a longitudinal axis of the first, second and third segments 260, 240, 230. The distance between the sheaths and the inside and outside of the segment 220 consequently changes along the longitudinal axis of the segment 220.

Owing to the conical design of the segment 220, the external diameter of the lower end 221 of the section 220 is greater than the external diameter of the upper end 222 to which the lower tower segments 102 are fastened. The bearing surface of the transition between the tower and the foundation can thus be increased without there being any need for the bearing surface or the external diameter of the lower tower segment 102 to be changed.

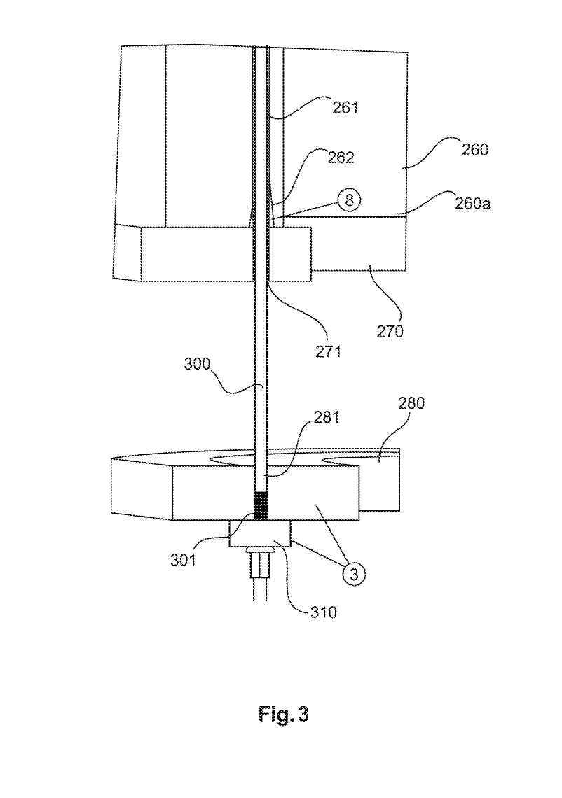

FIG. 3 shows a further view in section of a transition between a foundation and a tower of a wind turbine according to the first exemplary embodiment. The metal or concrete ring 280, the metal or concrete ring 270 and the first foundation segment 260 are shown in FIG. 3. The two rings 280, 270 have multiple openings or through bores 271, 281 which serve to receive the multiple tensioning rods 300. Multiple bolts 310 can be tensioned beneath the ring 280.

Multiple through holes, through bores or sheaths 261 for receiving the tensioning rods 300 are provided in the first segment 260. At the lower end 260a, the first segment 260 can have multiple conical bores 262 or a conical circumferential groove adjoining the through bores or through holes 261. The conical bores 262 are provided so as to make it easier to thread tensioning rods 300.

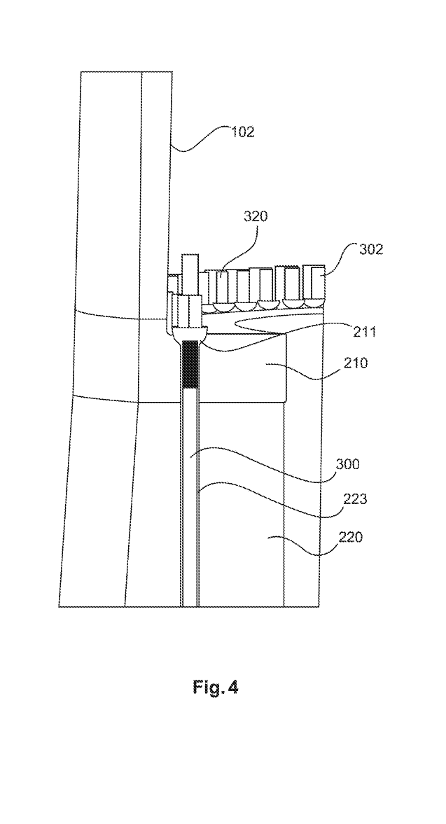

FIG. 4 shows a further schematic view in section of a transition between a foundation and a tower of the wind turbine according to the first exemplary embodiment. The segment 220, the flange 210 and the lower tower segment 102 are shown in FIG. 4. The flange 210 can, for example, be welded to the lower tower segment 108. Multiple through holes or through bores or sheaths 223 are provided in the segment 220. These through holes or sheaths 223 serve to receive the tensioning rods 300. The flange 210 can, in the region of the through holes 223, have multiple conical bores 211 at its upper end. The conical bores 211 serve to receive at least partially the tensioning bolts 320.

A pin ring, for example in the form of a concrete ring 270 can be embedded in the concrete of the foundation. The ring can also be made from steel. The first concrete segment 260 of the base 200 can be placed on the ring 270. A fireproof seal 250 can be provided on the first concrete segment 260. Multiple through holes, through which tensioning rods 300 can be pushed, can be provided in the first concrete segment 260 in the longitudinal direction. The number can be reduced by using tensioning rods instead of tensioning strands. A levelling ring can optionally be provided. A second segment 240 made of concrete or steel can be provided above the first concrete segment 260. This second segment 240 can optionally also have through bores in the longitudinal direction for receiving the tensioning rods. Alternatively, tensioning rods can also extend inside the second segment 240. A third segment 230, which can be made from steel or concrete, can be placed on the second segment 240. This third segment 230 can also have, in the longitudinal direction, through holes or bores 231 for receiving the tensioning rods 300. A conical segment 220 made of concrete can be provided on this third segment 230. The external diameter of the first lower end 221 is hereby greater than the external diameter of the second upper end 222. The internal diameter of the first end 221 is greater than the internal diameter of the second end 222. A steel ring or flange 210 can be placed on the second end 222 of the concrete segment 220. The concrete segment 220 has multiple through holes 223 in the longitudinal direction of the segment 220. Owing to the conical design of the concrete segment 220, the distance between the through holes 223 for receiving the tensioning rods at the first end towards the outside is greater than at the second end. This is provided in such a way to enable straight tensioning rods 300 to be used.

The tensioning rods 300 can also be designed as tensioning bars 300. Gaskets 290 can optionally be provided between the respective segments 260, 240, 220.

According to the invention, tensioning rods or tensioning bars 300 are used in order to tension together the ready-made concrete segments of the tower, the steel segments and the foundation or the segments of the base 200. According to the invention, multiple tensioning rods or tensioning bars 300 are provided. A bottom concrete segment 260 can optionally be connected via a concrete ring 280 which is embedded in the concrete of the foundation. The respective segments 260, 240, 220 can each have at their first ends (lower end) conical holes which make it easier to thread the foundation cage or the segments of the base over the tensioning rods.

The solution according to the invention makes it possible to dispense with a large number of steel flange connections. Moreover, rapid mounting and the use of more cost-effective concrete segments can be effected. The amount of material used can be reduced depending on the loading. Manufacturing tolerances can be compensated by means of the concrete ring 270 and/or the gaskets 290.

According to a further exemplary embodiment of the invention, the conical segment 220 can be designed in such a way that the distance between the through holes and the external diameter is constant. In this case, the tensioning bars must have a conical arrangement or design.

By virtue of the design according to the invention of the transition between the foundation and the tower, and the use of the tensioning bars or tensioning rods, it is possible to dispense with an anchoring basement. Moreover, the diameter of the flanges in the transition region between the foundation and the tower can be increased.

The present invention relates to a connection of a steel tubular section to concrete parts and a concrete foundation. It should be noted that the forces are hereby directed from the tower into the foundation.

A hybrid solution for the connection of the steel tubular section to concrete parts and the concrete foundation can be provided. By virtue of the design of the conical concrete segment 220, the diameter of the segments 240 and 260 and of the steel or concrete rings 270, 280 can be selected to be greater than the diameter of the lower tower segment 102.

A tower base can be provided with an embedded anchor region. According to the invention, a lower anchor ring 280 is provided. This anchor ring 280 can be made from an ultra-high-strength material. One end of the tensioning bars 300 can, for example, be fastened to the anchor ring 280 by segment anchors or corresponding nuts.

The segments 230, 240 and 260 can be made from a concrete with a lower concrete quality since the surface area is greater owing to the larger diameter. The concrete ring can be placed on the foundation in the dry state. The steel flange 210 can, for example, be designed as an L-shaped flange and can have a circumferential conical groove 211. From this conical groove 211, the bores extend in the flange 210 through which the tensioning rods 300 need to be pushed. In order to protect further the tensioning bars in the through holes in the segments 260, 240, 230, 220, the through holes can be packed with grease.

The segments 220, 230, 240, 260 each have multiple sheaths 223, 231, 241, 261 for receiving tensioning rods 300. The lower ends of the tensioning rods are fastened to the ring 280. The upper ends of the tensioning rods are tensioned to the flange 210 by means of corresponding bolted connections.

A tower base can be provided with an embedded anchor region. It is thus possible to avoid the need for a foundation basement. According to one aspect of the present invention, a tower base consisting of multiple segments 260, 240, 230, 220 can be provided and mounted, for example, as part of the foundation before a lower tower segment is placed on it. Some of the segments of the tower base can hereby already be cast in concrete before the first tower segment is put in place. The top segment 220 of the tower base 200 has in particular a conical design.

A lower tower segment 102 can be tensioned, via an L-shaped flange 210, to the tower base 200 consisting of the segments.

Tensioning strands or tensioning cables can optionally be used instead of the rods.

1. A wind turbine comprising:
a foundation including a foundation material and a tower base that extends longitudinally and is at least partially embedded in the foundation material, the tower base includes at least two precast concrete segments;
a tower including a lower tower segment; and
tensioning rods, tensioning cables, or tensioning strands tensioning together the at least two precast concrete segments and the lower tower segment.

2. The wind turbine according to claim 1, wherein the tower base includes an upper segment that is conical shaped with a plurality of through openings, through holes or sheaths configured to receive the tensioning rods, tensioning cables, or tensioning strands,
wherein the through openings, through holes or sheaths extend parallel to a longitudinal direction of the tower base.

3. The wind turbine according to claim 1, wherein an external diameter of the lower tower segment is smaller than an external diameter of the lower end of the tower base.

4. The wind turbine according to claim 1 wherein the foundation material is concrete, the wind turbine further comprising:
an anchor ring embedded in the concrete of the foundation as part of the tower base and tensions first ends of the tensioning rods, tensioning strands or tensioning cables, and
wherein second ends of the tensioning rods are tensioned to a flange coupled to an upper end of the tower base or to a lower end of the lower tower segment.

5. The wind turbine according to claim 1, wherein the tower includes a plurality of tower segments, the wind turbine comprising:
a fireproof seal fastened to one of the segments of the tower base or to one of the plurality of tower segments.

6. The wind turbine according to claim 1, wherein the tower includes a plurality of tower segments, the wind turbine comprising:
a projection on one of the at least two precast concrete segments of the tower base or the lower tower segment; and
a fireproof seal bearing against the projection.

7. A wind turbine tower, comprising:
a foundation including concrete and a tower base, the tower base having a first portion embedded in the concrete and a second portion extending out of the concrete, the tower base including a plurality of segments, the plurality of segments including a plurality of openings, sheaths or through holes;
a plurality of tower segments supported by the foundation; and
tensioning rods, tensioning strands or tensioning cables in the plurality of openings, sheaths or through holes of the plurality of segments, the tensioning rods, tensioning strands or tensioning cables having first ends coupled to the tower base and second ends coupled to one of the plurality of tower segments.

8. The wind turbine tower according to claim 7 wherein the second ends of the tensioning rods, tensioning cables, or tensioning strands are coupled to a lowest one of the plurality of tower segments.

9. The wind turbine tower according to claim 8 wherein an external diameter of the lowest one the plurality of tower segment is smaller than an external diameter of the plurality of segments of the tower base.

10. The wind turbine tower according to claim 9 wherein the second ends of the plurality of tensioning rods, tensioning strands or tensioning cables are coupled directly to a flange, wherein the flange is coupled directly to the lowest one of the plurality of tower segments.
